(19) United States
(12) Patent Application Publication
(10) Pub. No.: US 2024/0281317 A1
(43) Pub. Date: Aug. 22, 2024

(54) FAILURE CAUSE IDENTIFICATION ASSISTING APPARATUS, FAILURE CAUSE IDENTIFICATION ASSISTING METHOD, AND FAILURE CAUSE IDENTIFICATION ASSISTING PROGRAM

(71) Applicant: Hitachi, Ltd., Tokyo (JP)

(72) Inventors: Mineyoshi MASUDA, Tokyo (JP); Kouichi MURAYAMA, Tokyo (JP); Jun MIZUNO, Tokyo (JP)

(21) Appl. No.: 18/240,376

(22) Filed: Aug. 31, 2023

(30) Foreign Application Priority Data
Feb. 22, 2023 (JP) 2023-025971

(51) Int. Cl. G06F 11/07; G06F 11/30; G06F 11/32

(52) U.S. Cl. CPC G06F 11/079; G06F 11/3075; G06F 11/327

(57) ABSTRACT

A management computer 100 which assists in identifying a cause of failure concerning execution of an application includes a CPU 101 and an HDD 103. The HDD 103 stores configuration information (configuration information, configuration change history) concerning configurations at a plurality of time points regarding a given target configuration object concerning execution of the application. The CPU 101 calculates a viewpoint-based difference score that is a difference score in each of a plurality of viewpoints between a current configuration and a past configuration regarding the given target configuration object concerning execution of the application.

### CROSS-REFERENCE TO RELATED APPLICATION

The present application claims priority from Japanese application JP2023-025971, filed on Feb. 22, 2023, the content of which is hereby incorporated by reference into this application.

### TECHNICAL FIELD

The present invention relates to technology to assist in identifying a cause of failure caused in an IT system.

### BACKGROUND ART

Companies and the like use IT systems in various tasks. Occurrence of failure in an IT system affects tasks and society, and therefore, shortening of time taken to eliminate the failure is considered to be important.

As technology to shorten the time taken to eliminate the failure, for example, technology in which a situation and handling know-how at a time of occurrence of failure are recorded, and the handling know-how is reused when a similar situation occurs is known (for example, see PTL 1).

Moreover, as technology to predict occurrence of failure, technology in which a situation immediately before occurrence of failure is recorded, and appearance of a similar situation is considered as a sign of failure is known (for example, see PTL 2).

### CITATION LIST

### Patent Literature

PTL 1: JP2014-134956A
PTL 2: JP2012-203684A

### SUMMARY OF INVENTION

### Technical Problem

An application in recent years is utilized while software and the like included in the application are updated and a configuration of the system which executes the application is changed depending on operating conditions. Therefore, identification of a cause of failure has become more difficult.

For example, when searching for a cause of failure which occurred in an application, output of a log, a trace, performance, and the like in a current configuration of a system which executes the application may be compared to output in a past configuration. However, the searching for the cause depends on experience of an expert who well knows the application.

Moreover, when software and the like included in the application are updated, or the configuration of the system which executes the application is changed, there are many cases in which the technology disclosed in PTL 1 cannot be utilized since a similar situation does not exist in the past.

The invention is made in view of the above situation, and an object thereof is to provide technology capable of easily and appropriately calculating information which is beneficial to identify a cause of failure.

### Solution to Problem

In order to achieve the above object, a failure cause identification assisting apparatus according to one aspect is a failure cause identification assisting apparatus which assists in identifying a cause of failure concerning execution of an application. The failure cause identification assisting apparatus includes a processor and a storage device. The storage device stores configuration information concerning configurations at a plurality of time points regarding a given target configuration object concerning execution of the application. The processor calculates a viewpoint-based difference score that is a difference score in each of a plurality of viewpoints between a current configuration and a past configuration regarding the given target configuration object concerning execution of the application.

### Advantageous Effects of Invention

According to the invention, information beneficial to identify a cause of failure can easily and appropriately be calculated.

### BRIEF DESCRIPTION OF DRAWINGS

FIG. 1 is a diagram illustrating an outline of one embodiment.

FIG. 2 is an entire configuration diagram of a computer system according to one embodiment.

FIG. 3 is a configuration diagram of a plugin repository according to one embodiment.

FIG. 4 is a configuration diagram of an application configuration to one table according embodiment.

FIG. 5 is a configuration diagram of an application configuration change history table according to one embodiment.

FIG. 6 is a configuration diagram of a software configuration table according to one embodiment.

FIG. 7 is a configuration diagram of a software configuration change history table according to one embodiment.

FIG. 8 is a configuration diagram of a storage configuration table according to one embodiment.

FIG. 9 is a configuration diagram of a storage configuration history table according to one embodiment.

FIG. 10 is a configuration diagram of a difference score table according to one embodiment.

FIG. 11 is a diagram illustrating a difference score calculation result screen according to one embodiment.

FIG. 12 is a diagram illustrating a difference detail screen according to one embodiment.

FIG. 13 is a flowchart of a plugin registering processing according to one embodiment.

FIG. 14 is a flowchart of a failure cause identification assisting processing according to one embodiment.

FIG. 15 is a flowchart of a difference score calculating processing according to one embodiment.

FIG. 16 is a flowchart of a past configuration creating processing according to one embodiment.

FIG. 17 is a flowchart of a viewpoint-based difference score calculating processing (a version of software of an application) according to one embodiment.

FIG. 18 is a flowchart of a viewpoint-based difference score calculating processing (a container configuration of the application) according to one embodiment.

FIG. 19 is a flowchart of a viewpoint-based difference score e calculating processing (a peripheral container) according to one embodiment.

FIG. 20 is a flowchart of a difference score displaying processing according to one embodiment.

FIG. 21 is a flowchart of a similar configuration recommendation adding processing according to one embodiment.

FIG. 22 is a flowchart of a viewpoint-based recommendation adding processing according to one embodiment.

FIG. 23 is a flowchart of a difference detail displaying processing according to one embodiment.

FIG. 24 is a flowchart of a beneficialness coefficient updating processing according to one embodiment.

### DESCRIPTION OF EMBODIMENT

An embodiment is described with reference to the drawings. Note that the embodiment described below does not limit the invention according to the claims, and not all of components described in the embodiment and combinations of the components are limited to be essential for solution in the invention.

Note that in the following description processing may be described while a “program” is considered as a subject of operation. The program performs a given processing while suitably using a storage resource (for example, a memory) and/or a communication interface device (for example, an NIC (Network Interface Card)) by the program being executed by a processor (for example, a CPU (Central Processing Unit)). Therefore, the subject of the processing may be the program. The processing whose operation subject is explained to be the program may be processing which is executed by a processor, or a computer or a system including the processor.

Moreover, in the following description, information may be described by expression of “AAA table”. However, the information may be expressed by any data structure. That is, the “AAA table” may be referred to as “AAA information” in order to indicate that the information does not depend on the data structure.

First, an outline of one embodiment is described.

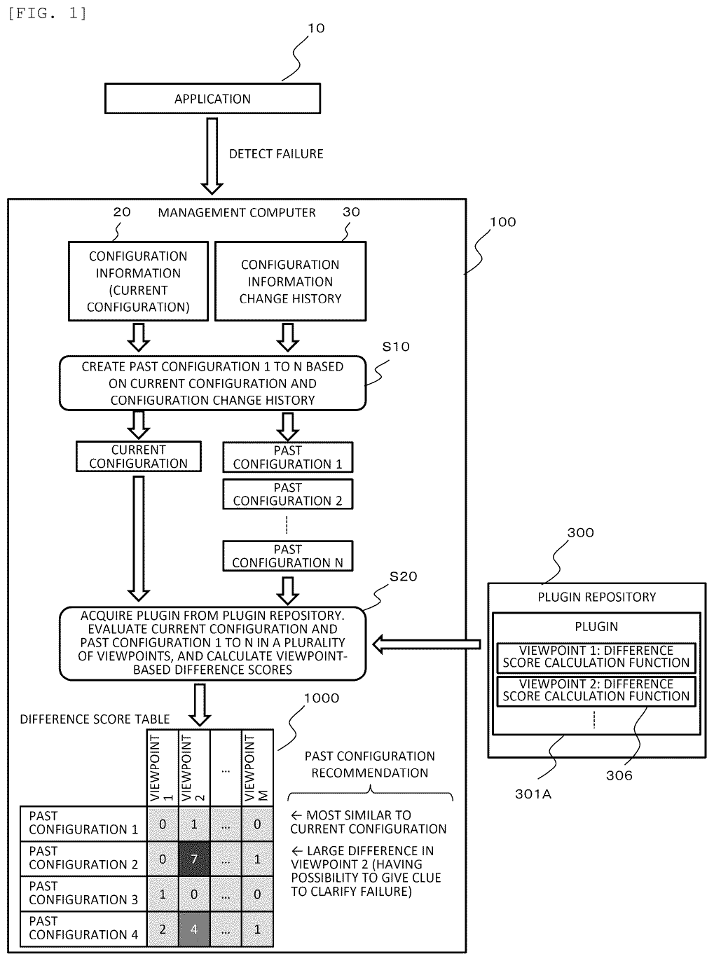

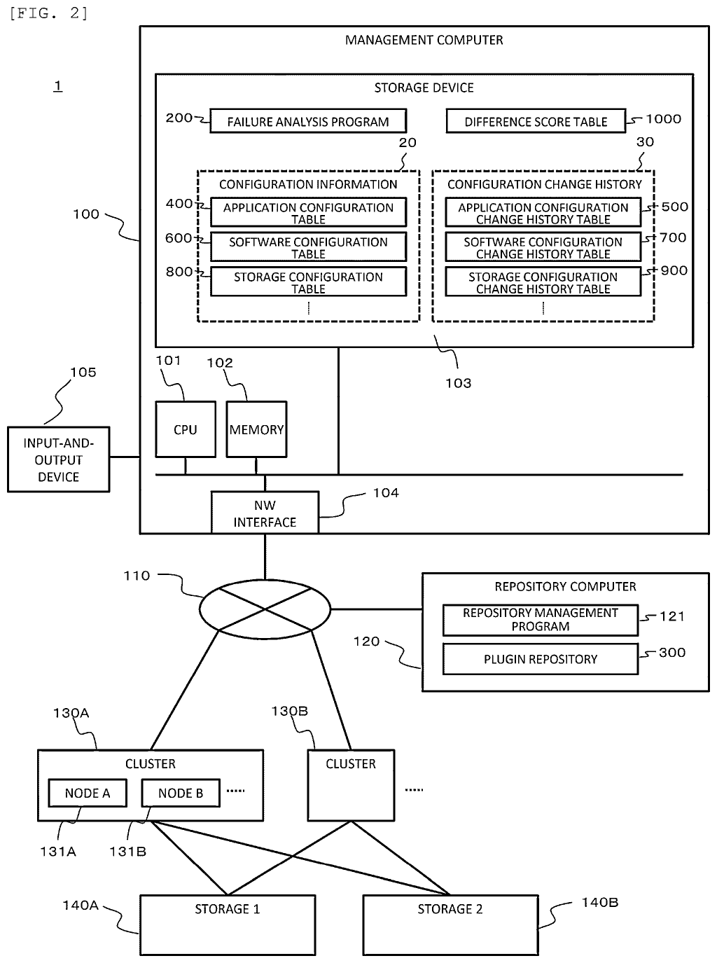

FIG. 1 is a diagram illustrating the outline of one embodiment.

When a management computer 100 as one example of a failure cause identification assisting apparatus according to one embodiment of the present invention detects failure in an application 10, the management computer 100 creates configurations at a plurality of time points in the past (past configurations 1 to N) based on a current configuration information 20 (a current configuration) and a configuration information change history 30, regarding a configuration object where occurrence of failure is suspected (a configuration item: a suspected configuration object, a suspected configuration item) among configuration objects which execute the application (S10). Here, the configuration items may be, for example, a container, a process, software, storage, a cluster, and a node.

Next, the management computer 100 acquires, from a plugin 301A in a plugin repository 300, difference score calculation functions 306 which are used to calculate difference scores regarding the respective viewpoints (viewpoint-based difference scores), and calculates the viewpoint-based difference scores which are difference scores in the plurality of viewpoints between each of the past configurations 1 to N and the current configuration by using the difference score calculation functions 306 (S20). Next, the management computer 100 creates a difference score table 1000 based on the viewpoint-based difference scores regarding each of the past configurations 1 to N. After this, based on the content of the difference score table 1000, the management computer 100 may output, as recommendation, a past configuration which is most similar to the current configuration, or a past configuration which is largely different in only one viewpoint (that is, having a possibility to give a clue to clarify the failure).

Next, a computer system according to one embodiment is described in detail.

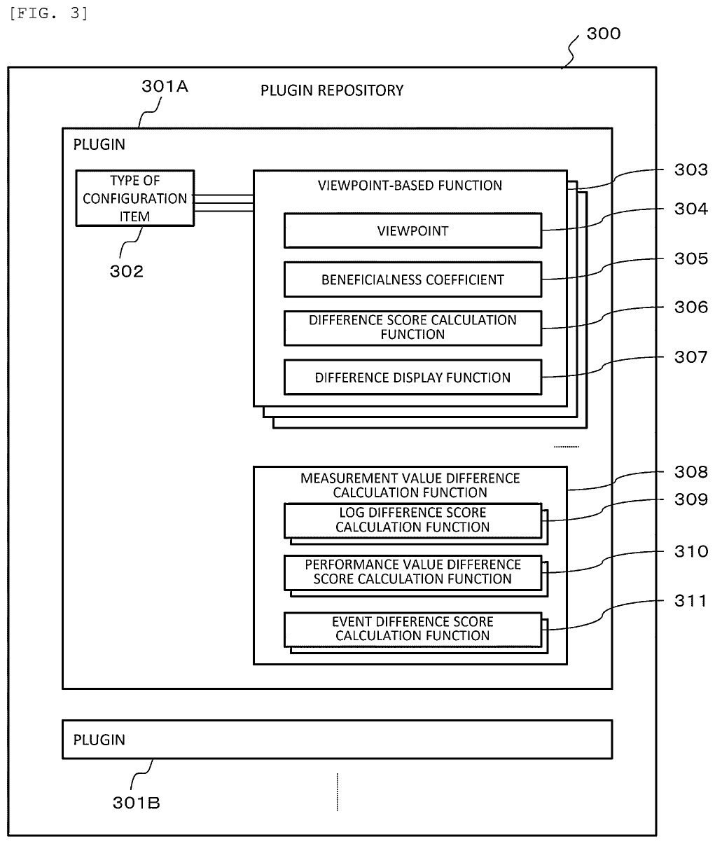

FIG. 2 is an entire configuration diagram of the computer system according to one embodiment.

A computer system 1 includes the management computer 100, a repository computer 120, one or more clusters 130 (130A, 130B, etc.), and one or more storages 140 (140A, 140B, etc.). The management computer 100, the repository computer 120, and the cluster 130 are connected to each other via a network 110. The network 110 is, for example, a communication path such as a wired LAN (Local Area Network) and a wireless LAN. The cluster 130 is connected to the one or more storages 140.

The cluster 130 includes one or more nodes 131 (131A, 131B, etc.) which execute an application. The storage 140 stores data concerning execution of the application.

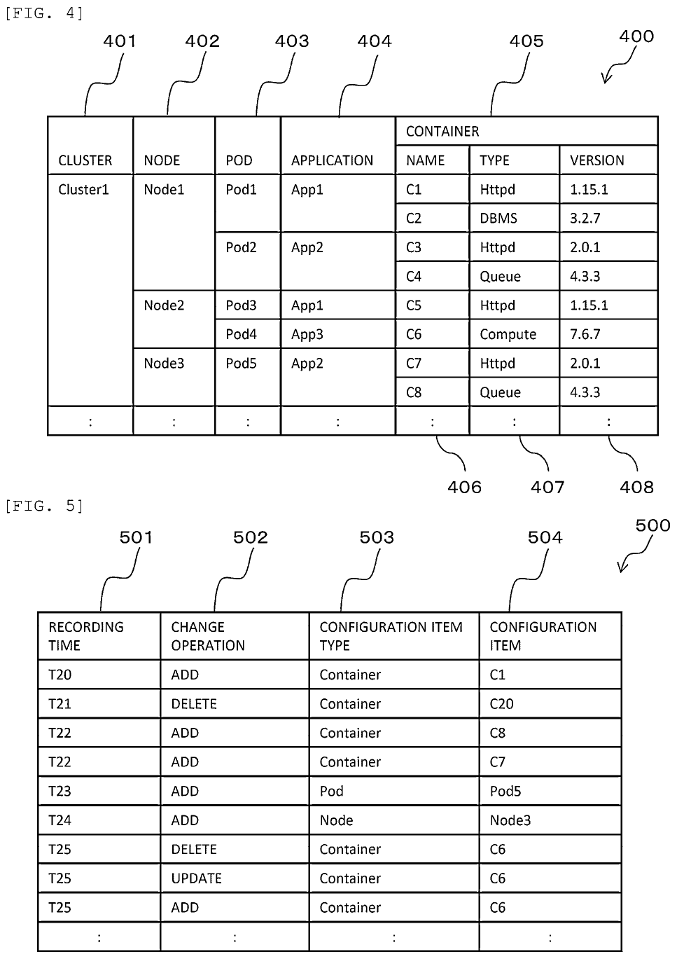

The repository computer 120 is, for example, a computer such as a PC (Personal Computer) and a general-purpose server. The repository computer 120 includes a repository management program 121 and the plugin repository 300. The repository management program 121 is executed by a processor (not illustrated) of the repository computer 120, and thus, performs managing processing of the plugin 301 (301A, 301B, etc.: see FIG. 3) (for example, update of the plugin 301, and transmission of the plugin 301) in the plugin repository 300. The plugin repository 300 will be described later. Note that the repository computer 120 may be configured by the management computer 100.

The management computer 100 is, for example, a computer such as a PC and a general-purpose server, and includes a CPU 101 as one example of a processor, a memory 102, a storage device 103, and a network (NW) interface 104. The management computer 100 is connected to an input-and-output device 105.

The NW interface 104 is, for example, an interface such as a wired LAN card and a wireless LAN card, and communicates with other devices (for example, the node 131 of the cluster 130, and the repository computer 120) via the network 110.

The CPU 101 executes various processing in accordance with programs stored in the memory 102 and/or the storage device 103.

The memory 102 is, for example, a RAM (Random Access Memory), and stores the program executed by the CPU 101 and necessary information.

The storage device 103 is, for example, a hard disk drive and a flash memory, and stores the program executed by the CPU 101, and data used by the CPU 101. In this embodiment, the storage device 103 stores a failure analysis program 200 as one example of a failure cause identification assisting program, and stores the difference score table 1000, the configuration information 20, and the configuration information change history 30 as the data. Processing by the failure analysis program 200 will be described later with reference to the flowcharts.

The configuration information 20 includes an application configuration table 400, a software configuration table 600, and a storage configuration table 800. The configuration information change history 30 includes an application configuration change history table 500, a software configuration change history table 700, and a storage configuration change history table 900. A configuration of each table stored in the storage device 103 will be described later.

The storage device 103 may store a past case database (a past case DB: past case information) including an event at a time of past failure occurrence and a handling example to the event occurrence, and measurement value information regarding the configuration item concerning the execution of the application. The measurement value information is, for example, information on a performance value related to performance (performance value information: e.g., a CPU usage rate and the number of processed requests), log information at the time of execution of the application (log information), and event information at the time of execution of the application (event information). Here, the event information is, for example, information extracted from the log information and including a given keyword, information on a given performance value extracted from the performance value information, and information extracted from the log information and the performance value information and satisfying a given condition.

The input-and-output device 105 includes an input device (for example, a mouse, a keyboard, etc.) which accepts input of information from a user, and an output device (for example, a display unit, etc.) which displays and outputs a user interface including various information.

Next, the plugin repository 300 is described in detail.

FIG. 3 is a configuration diagram of the plugin repository according to one embodiment.

The plugin repository 300 stores the one or more plugins 301 (301A, 301B, etc.) corresponding to types of the configuration items. Here, the configuration item is an item concerning execution of the application, and may be, for example, a container, a pod, a process, software, storage, a cluster, or a node.

The plugin 301 includes a type 302 of the configuration item corresponding to the plugin 301, a plurality of viewpoint-based functions 303 concerning the respective viewpoints regarding the configuration item corresponding to the plugin 301, and a measurement value difference calculation function 308 for calculating difference in a measurement value regarding the configuration item corresponding to the plugin 301.

Each viewpoint-based function 303 includes a viewpoint 304, a beneficialness coefficient 305, the difference score calculation function 306, and a difference display function 307. The viewpoint 304 is a content of the viewpoint corresponding to the viewpoint-based function 303. The content of the viewpoint includes, for example, when the configuration item is a container, a version of software included in an application executed by the container, a configuration of the container, another container (a peripheral container) executed in the same node as the above-mentioned container, a time window during which the application is executed by the container, and the like. The beneficialness coefficient 305 is a beneficialness coefficient used for correction at the time of calculation of the difference score. The beneficialness coefficient is managed such that its value increases when the viewpoint-based difference score calculated using the difference score calculation function 306 is fed back to be beneficial by a user. The difference score calculation function 306 is a function to calculate the viewpoint-based difference score between the current configuration and the past configuration regarding the viewpoint corresponding to the viewpoint-based function 303. The difference display function 307 is a function to perform processing to display on a screen the viewpoint-based difference score regarding the viewpoint corresponding to the viewpoint-based function 303.

The measurement value difference calculation function 308 includes one or more log difference score calculation functions 309, one or more performance value difference score calculation functions 310, and one or more event difference score calculation functions 311. The log difference score calculation function 309 is a function to calculate a difference score regarding a log. The performance value difference score calculation function 310 is a function to calculate a difference score regarding a performance value. The event difference score calculation function 311 is a function to calculate a difference score regarding an event.

Next, the application configuration table 400 is described in detail.

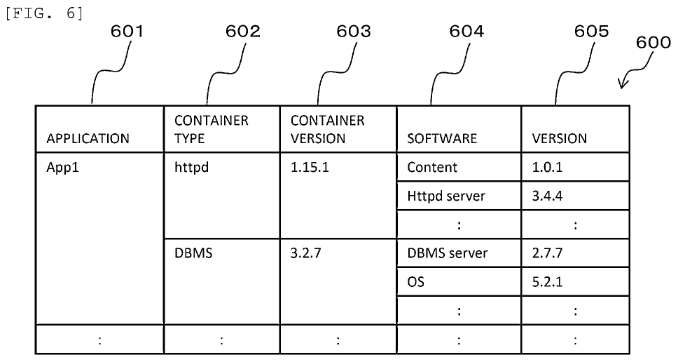

FIG. 4 is a configuration diagram of the application configuration table according to one embodiment.

The application configuration table 400 is a table which manages a configuration of the container which executes the application. An entry of the application configuration table 400 includes fields of a cluster 401, a node 402, a pod 403, an application 404, and a container 405.

The cluster 401 stores an identification name of the cluster which executes the application. The node 402 stores an identification name of the node which executes the application. The pod 403 stores an identification name of the pod which executes the application. Here, the pod is a basic execution unit which executes the application, and the pod includes one or more containers. The application 404 stores an identification name of the application which is executed. The container 405 stores information on the container which executes the application, and includes fields of a name 406, a type 407, and a version 408. The name 406 stores a name of the container. The type 407 stores a type of the container. The version 408 stores a version number of the container.

Next, the application configuration change history table 500 is described in detail.

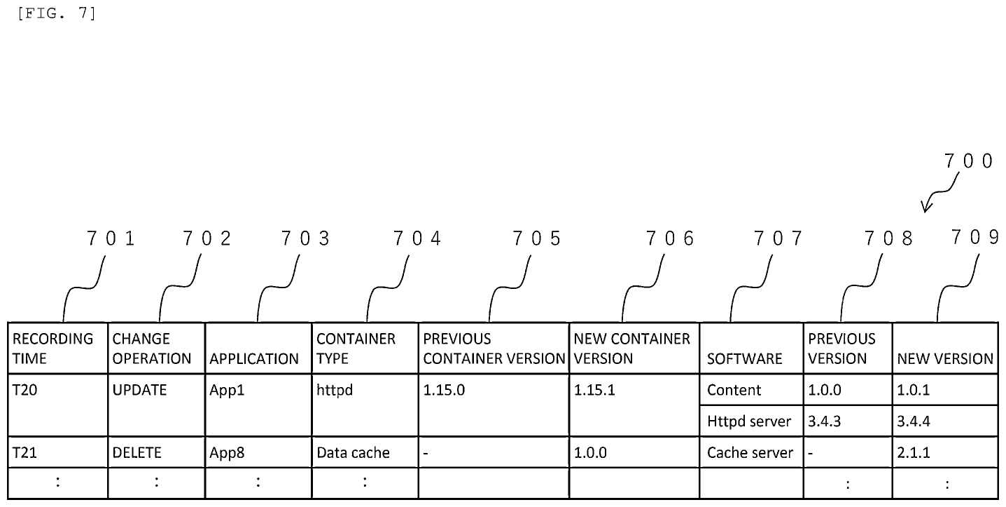

FIG. 5 is a configuration diagram of the application configuration change history table according to one embodiment.

The application configuration change history table 500 is a table which manages a change history of changing in the configuration item (here, the container, the pod, the node, etc.) which executes the application. The application configuration change history table 500 stores an entry for each configuration change of the configuration item. The entry of the application configuration change history table 500 includes fields of a recording time 501, a change operation 502, a configuration item type 503, and a configuration item 504.

The recording time 501 stores a time when the change corresponding to the entry is applied. The change operation 502 stores a change operation corresponding to the entry. The change operation is, for example, adding, deleting, updating, and the like. The configuration item type 503 stores the type of the configuration item applied with the change corresponding to the entry. The configuration item 504 stores the name of the configuration item applied with the change corresponding to the entry.

Next, the software configuration table 600 is described in detail.

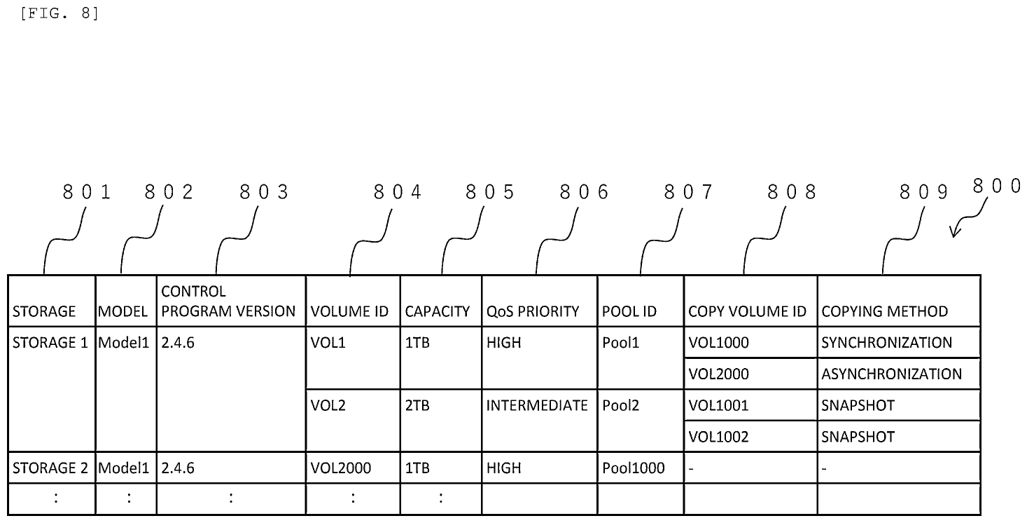

FIG. 6 is a configuration diagram of the software configuration table according to one embodiment.

The software configuration table 600 is a table which manages a configuration of software included in the application, and the software configuration table 600 stores an entry for each application. The entry of the software configuration table 600 includes fields of an application 601, a container type 602, a container version 603, a software 604, and a version 605.

The application 601 stores the name of the application corresponding to the entry. The container type 602 stores the type of the container used for execution of the application corresponding to the entry. The container version 603 stores the version number of the container used for execution of the application corresponding to the entry. The software 604 stores a name of one or more pieces of software included in the application corresponding to the entry. The version 605 stores a version number of the corresponding software.

Next, the software configuration change history table 700 is described in detail.

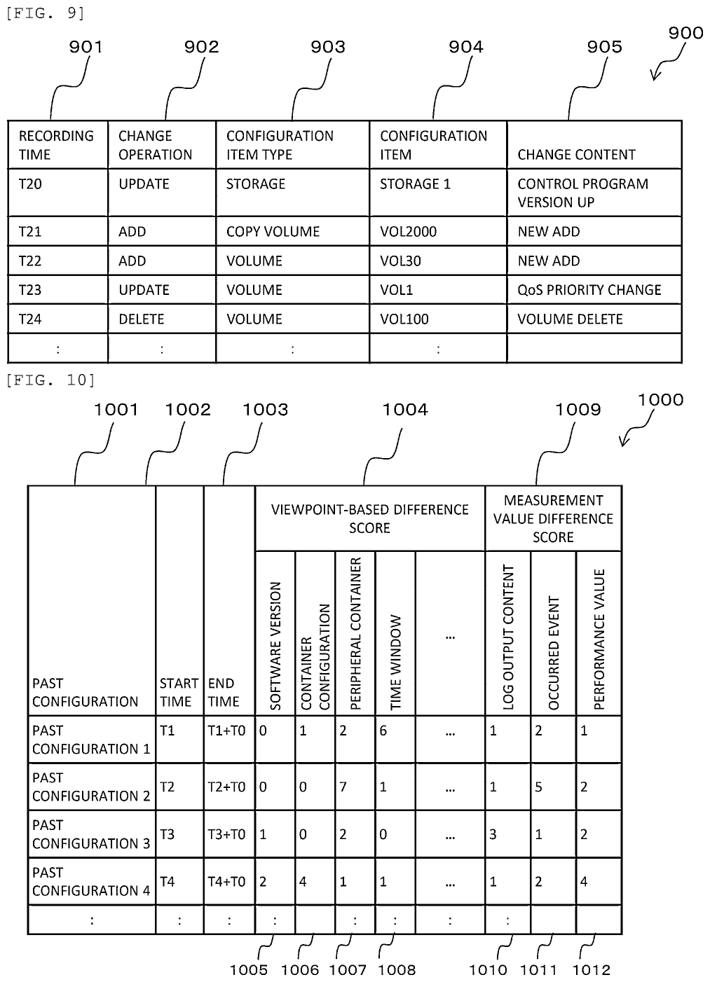

FIG. 7 is a configuration diagram of the software configuration change history table according to one embodiment.

The software configuration change history table 700 is a table which manages a history of configuration change of the software of the application, and the software configuration change history table 700 stores an entry for each configuration change of the software. The entry of the software configuration change history table 700 includes fields of a recording time 701, a change operation 702, an application 703, a container type 704, a previous container version 705, a new container version 706, a software 707, a previous version 708, and a new version 709.

The recording time 701 stores a time when change is applied to the software corresponding to the entry. The change operation 502 stores a change operation to the software corresponding to the entry. The change operation is, for example, adding, deleting, updating, and the like. The application 703 stores the name of the application including the software corresponding to the entry. The container type 704 stores the type of the container where the software corresponding to the entry is executed. The previous container version 705 stores the version number of the container before the change of the software corresponding to the entry. The new container version 706 stores the version number of the container after the change of the software corresponding to the entry. The software 707 stores the name of the software corresponding to the entry. The previous version 708 stores the version number of the software corresponding to the entry before the change. The new version 709 stores the version number of the software corresponding to the entry after the change.

Next, the storage configuration table 800 is described in detail.

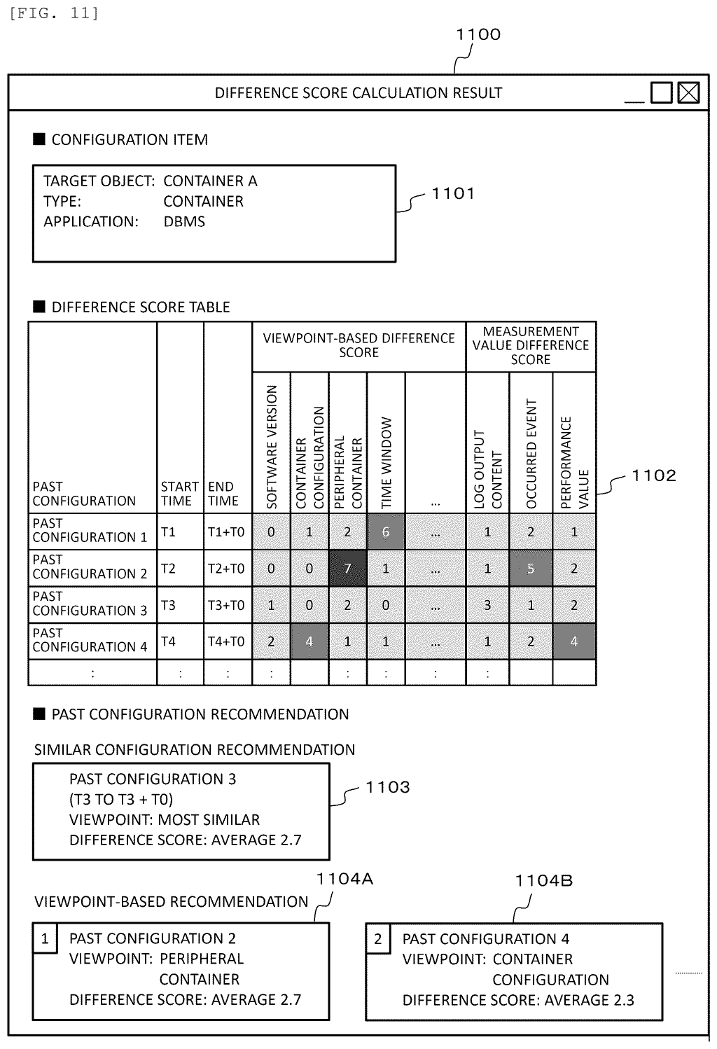

FIG. 8 is a configuration diagram of the storage configuration table according to one embodiment.

The storage configuration table 800 is a table which manages a configuration of the storage 140, and the storage configuration table 800 stores an entry for each storage. The entry of the storage configuration table 800 includes fields of a storage 801, a model 802, a control program version 803, a volume ID 804, a capacity 805, a QoS priority 806, a pool ID 807, a copy volume ID 808, and a copying method 809.

The storage 801 stores a name of the storage corresponding to the entry. The model 802 stores a model name of the storage corresponding to the entry. The control program 803 stores a version number of a control program of the storage corresponding to the entry. The volume ID 804 stores an ID of a volume (a volume ID) of the storage corresponding to the entry. The capacity 805 stores a capacity of the volume of the volume ID in the entry. The QoS priority 806 stores priority in QoS (Quality of Service). The pool ID 807 stores an ID of a pool (a pool ID) which provides a storage area to the volume of the volume ID corresponding to the entry. The copy volume ID 808 stores an ID of a volume (a copy volume) to which the volume of the volume ID corresponding to the entry is copied. The copying method 809 stores a method of copying (a copying method) to the copy volume. The copying method is, for example, synchronization in which copying is synchronously performed, asynchronization in which copying is asynchronously performed, a snapshot utilizing a snapshot, and the like.

Next, the storage configuration change history table 900 is described in detail.

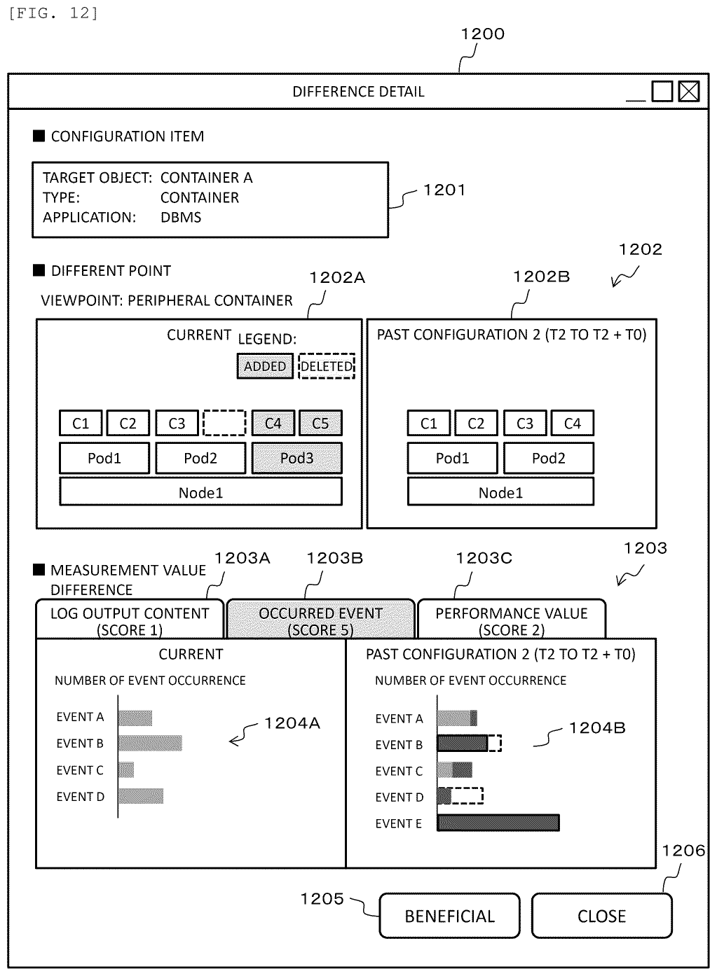

FIG. 9 is a configuration diagram of the storage configuration change history table according to one embodiment.

The storage configuration change history table 900 is a table which manages a change history of the configuration of the storage 140, and the storage configuration change history table 900 stores an entry for each configuration change of the storage. The entry of the storage configuration change history table 900 includes fields of a recording time 901, a change operation 902, a configuration item type 903, a configuration item 904, and a change content 905.

The recording time 901 stores a time when the change corresponding to the entry is applied. The change operation 902 stores a change operation corresponding to the entry. The change operation is, for example, adding, deleting, updating, and the like. The configuration item type 903 stores a type of the configuration item of the storage (a configuration item type) applied with the change corresponding to the entry. The configuration item type is, for example, a storage, a copy volume, a volume, and the like. The configuration item 904 stores the name of the configuration item (the storage, the volume, etc.) applied with the change corresponding to the entry. The change content 905 stores a content of the change corresponding to the entry.

Next, the difference score table 1000 is described in detail.

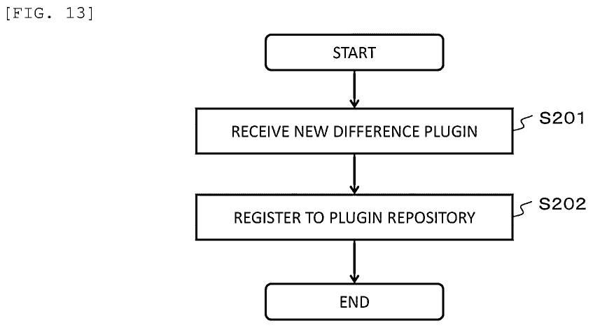

FIG. 10 is a configuration diagram of the difference score table according to one embodiment.

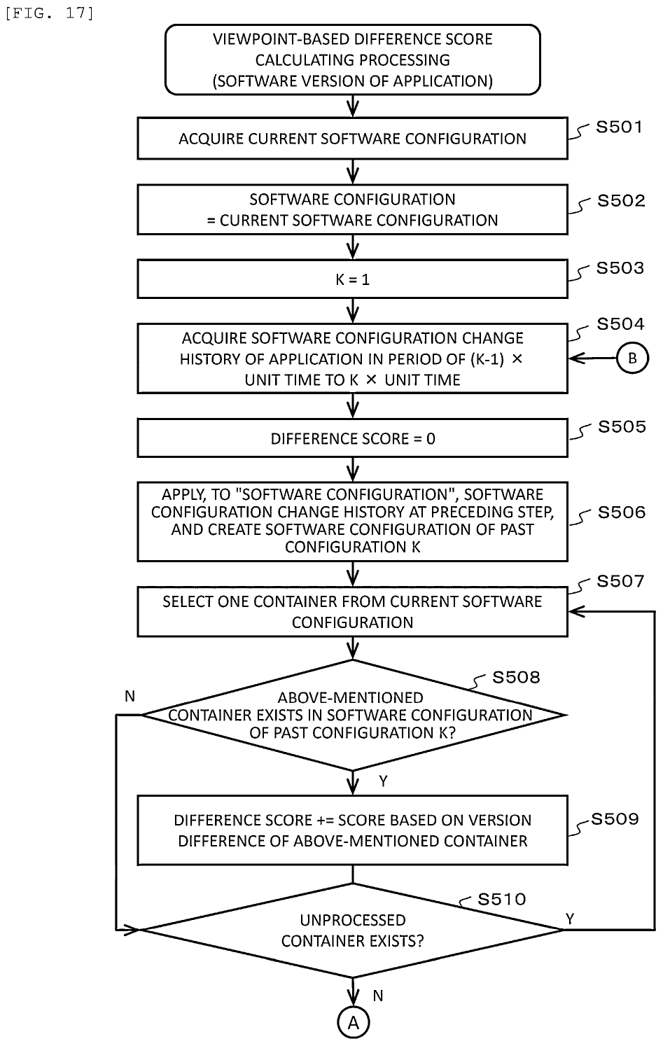

The difference score table 1000 is a table which manages the viewpoint-based difference scores and the measurement value difference scores regarding a plurality of past configurations. The difference score table 1000 is created through a failure cause identification assisting processing which will be described later (see FIG. 14). The difference score table 1000 stores an entry for each past configuration. The entry of the difference score table 1000 includes fields of a past configuration 1001, a start time 1002, an end time 1003, a viewpoint-based difference score 1004, and a measurement value difference score 1009.

The past configuration 1001 stores a name of the past configuration corresponding to the entry. The start time 1002 stores a time when the past configuration corresponding to the entry starts. The end time 1003 stores a time when the past configuration corresponding to the entry ends. The viewpoint-based difference score 1004 stores the viewpoint-based difference scores of the past configuration corresponding to the entry in a plurality of viewpoints. In this embodiment, the viewpoint-based difference score 1004 includes fields of a software version 1005, a container configuration 1006, a peripheral container 1007, and a time window 1008.

The software version 1005 stores a viewpoint-based difference score in a viewpoint of a software version. The container configuration 1006 stores a viewpoint-based difference score in a viewpoint of a container configuration. The peripheral container 1007 stores a viewpoint-based difference score in a viewpoint of peripheral container. The time window 1008 stores a viewpoint-based difference score in a viewpoint of an execution time window.

The measurement value difference score 1009 stores a difference score (the measurement value difference score) concerning the measurement value of the past configuration corresponding to the entry. In this embodiment, the measurement value difference score 1009 includes fields of a log output content 1010, an occurred event 1011, and a performance value 1012.

The log output content 1010 stores a difference score regarding a measurement value concerning an output content of a log (for example, the number of outputs of a given log). The occurred event 1011 stores a difference score regarding a measurement value concerning an event which occurred (for example, the number of occurrences of the event). The performance value 1012 stores a difference score regarding a performance value of the configuration which executes the application (for example, a usage rate of a used CPU, and the number of processed requests).

Next, a difference score calculation result screen 1100 outputted by the management computer 100 is described.

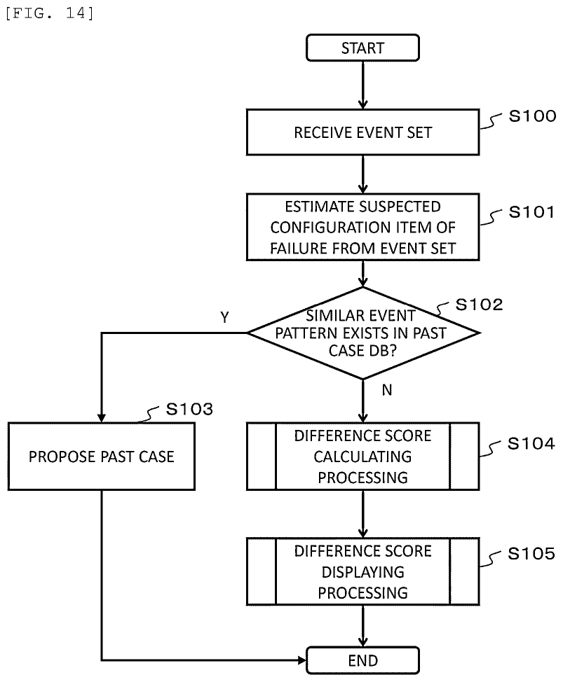

FIG. 11 is a diagram illustrating the difference score calculation result screen according to one embodiment.

The difference score calculation result screen 1100 is a screen displayed through the failure cause identification assisting processing which will be described later (see FIG. 14).

The difference score calculation result screen 1100 includes a configuration item displaying range 1101, a difference score table displaying range 1102, a similar configuration recommendation displaying range 1103, and a viewpoint-based recommendation displaying range 1104 (1104A and 1104B).

In the configuration item displaying range 1101, the configuration item (for example, the suspected configuration item) which is the target object of displaying the difference score, the type of the target configuration item, and the application are displayed.

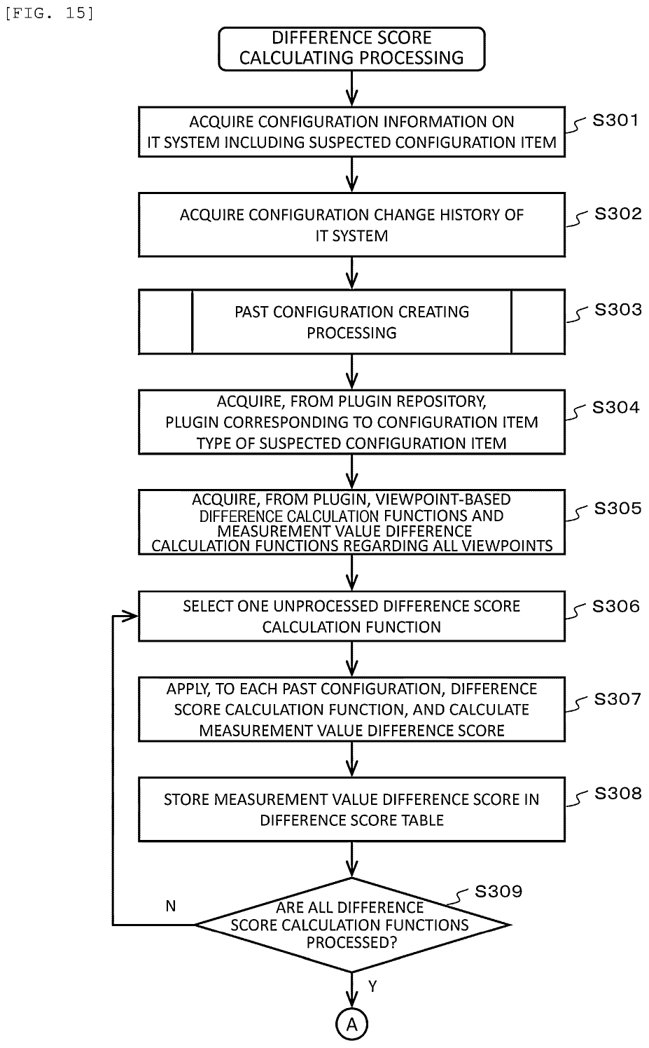

In the difference score table displaying range 1102, a difference score table created based on the difference score table 1000 generated through the failure cause identification assisting processing is displayed. Note that on the display screen, for example, when the difference score is at or larger than a given value, the displaying range of the difference score is displayed to be highlighted compared to the other ranges. Moreover, in this embodiment, by the range of the viewpoint-based difference score of the past configuration in the difference score table displaying range 1102 being pressed, a difference detail screen which shows in detail the difference regarding the pressed viewpoint of the past configuration is displayed (see FIG. 12).

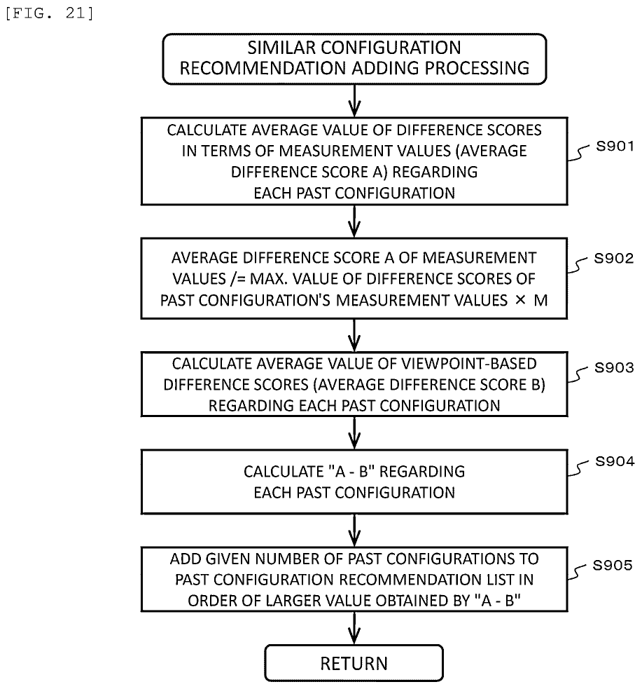

In the similar configuration recommendation displaying range 1103, recommendation based on the content of the past configuration which is added to a past configuration recommendation list through a similar configuration recommendation adding processing which will be described later (see FIG. 21) is shown. Here, the content of the recommendation may include, for example, the name of the past configuration which is recommended (a recommended past configuration), the start time and the end time of this past configuration, a viewpoint in which this past configuration is selected as the recommendation (in this case, being most similar), and an average score of the difference scores regarding this past configuration.

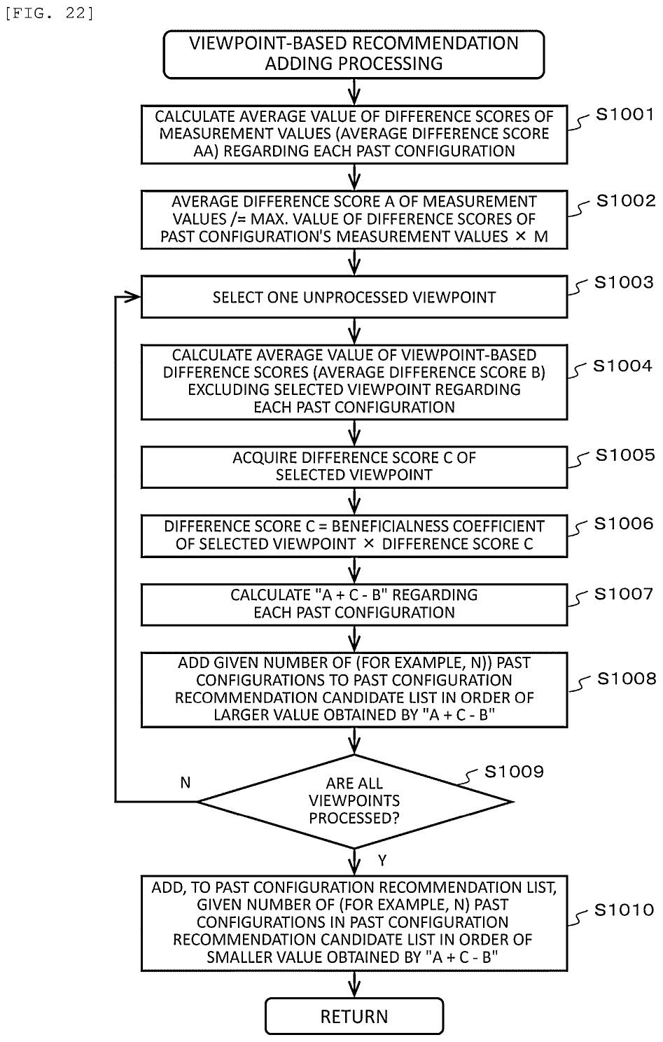

In the viewpoint-based recommendation displaying range 1104, recommendation based on a content of the past configuration added to the past configuration recommendation list through a viewpoint-based recommendation adding processing which will be described later (see FIG. 22) is displayed. Here, the content of the recommendation may include, for example, the name of the past configuration which is recommended (the recommended past configuration), the start time and the end time of this past configuration, a viewpoint in which this past configuration is selected as the recommendation (a recommended viewpoint), and the average score of the difference scores regarding this past configuration.

Next, a difference detail screen 1200 is described.

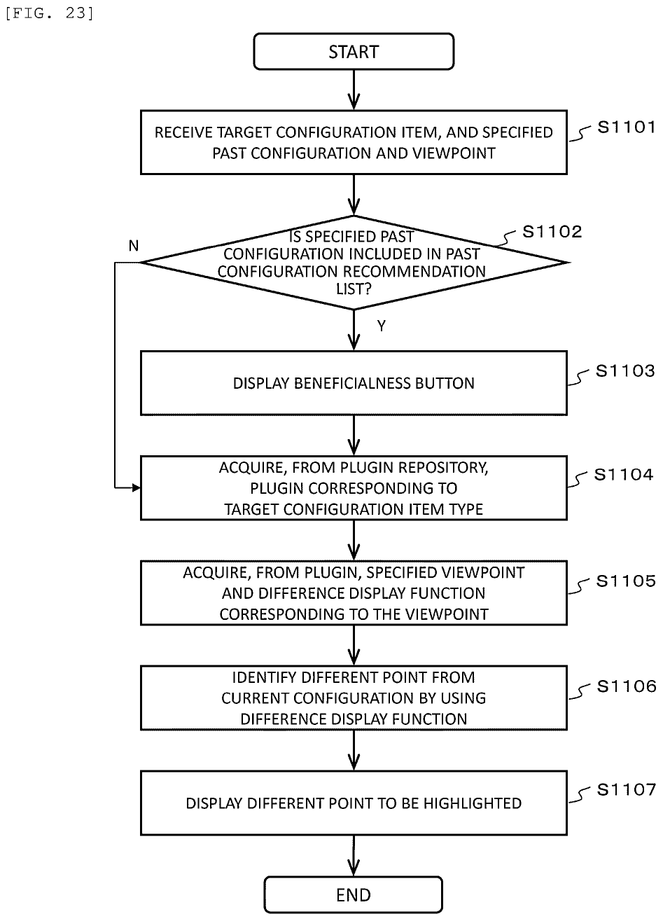

FIG. 12 is a diagram illustrating the difference detail screen according to one embodiment. Note that FIG. 12 is a difference detail screen regarding a past configuration 2 illustrated in FIG. 11. The difference detail screen 1200 is displayed, for example, through a difference detail displaying processing which will be described later (see FIG. 23).

The difference detail screen 1200 includes a configuration item displaying range 1201, a different point displaying range 1202, a measurement value difference content displaying range 1203, a beneficialness button 1205, and a close button 1206.

In the configuration item displaying range 1201, the configuration item (the target configuration item) which is the target object of the difference detail screen, the type of the target configuration item, and the application are displayed.

In the different point displaying range 1202, difference in the configuration between the current configuration and the past configuration regarding the viewpoint where difference in the viewpoint-based difference score in terms of the target configuration item is at or larger than a given value is displayed. In this embodiment, the different range 1202 includes a current configuration displaying range 1202A where the current configuration regarding the target configuration item is displayed, and a past configuration displaying range 1202B where the past configuration regarding the target configuration item is displayed. In the current configuration displaying range 1202A, a part different from the past configuration is displayed to be highlighted compared to the other parts.

In the measurement value difference content displaying range 1203, contents of difference regarding a plurality of measurement value differences are selectably displayed. In the example in FIG. 12, in the measurement value difference content displaying range 1203, a difference content 1203A regarding the log output content, a difference content 1203B regarding the occurred event, and a difference content 1203C regarding the performance value are arranged to be overlapped with each other, and by a tab part being selected, the corresponding difference content can be checked. The example in FIG. 12 shows a state where the difference content 1203B regarding the occurred event is selected. The difference content 1203B regarding the occurred event includes a current content displaying range 1204A where the number of occurrences of the event in the current configuration is displayed, and a past content displaying range 1204B where the number of occurrences of the event in the past configuration is displayed. In the difference content 1203B regarding the occurred event, a part which is different between the current content and the past content is displayed to be highlighted. Also when the difference content 1203A regarding the log output content, or the difference content 1203C regarding the performance value is selected, the current content and the past content corresponding to each of the difference content 1203A and the difference content 1203C are displayed.

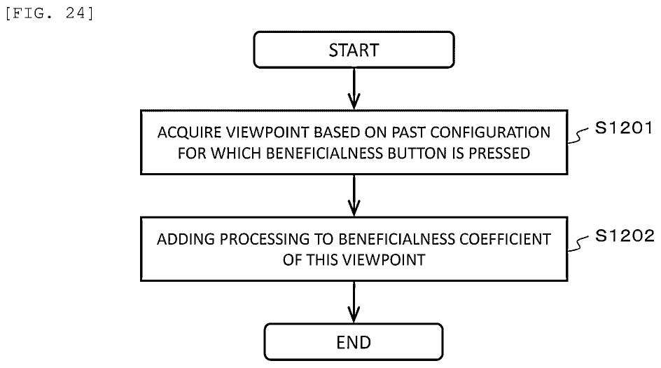

The beneficialness button 1205 is a button which is displayed when the past configuration which is the target object of the difference detail screen is the recommended past configuration. The beneficialness button 1205 is pressed when a user thinks that the information on the difference regarding the displayed viewpoint of the displayed past configuration is beneficial to identify the cause of failure. When the beneficialness button 1205 is pressed, a beneficialness coefficient updating processing which will be described later (see FIG. 24) is executed. In the beneficialness coefficient updating processing, a beneficialness coefficient which adjusts the difference score regarding the viewpoint displayed on the difference detail screen is updated.

The close button 1206 is a button which is pressed to close the difference detail screen 12, and the difference detail screen 12 is closed when the close button 1206 is pressed.

Next, processing operation by the computer system 1 is described.

First, a plugin registering processing to register the new plugin 301 to the repository computer 120 is described.

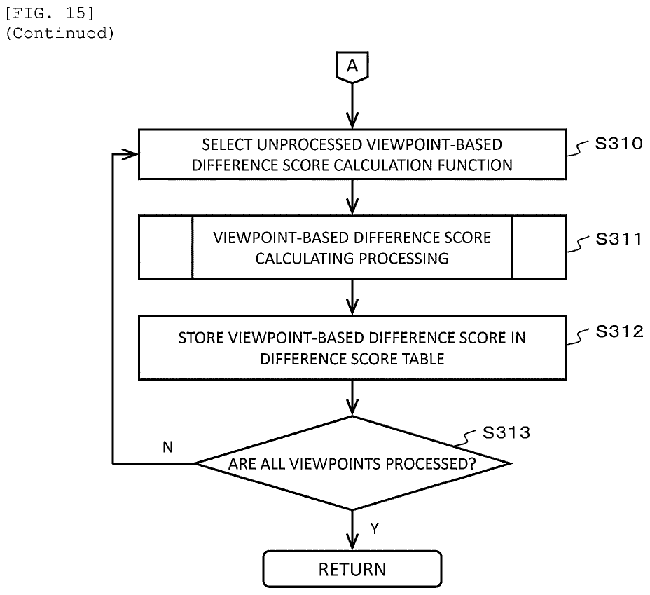

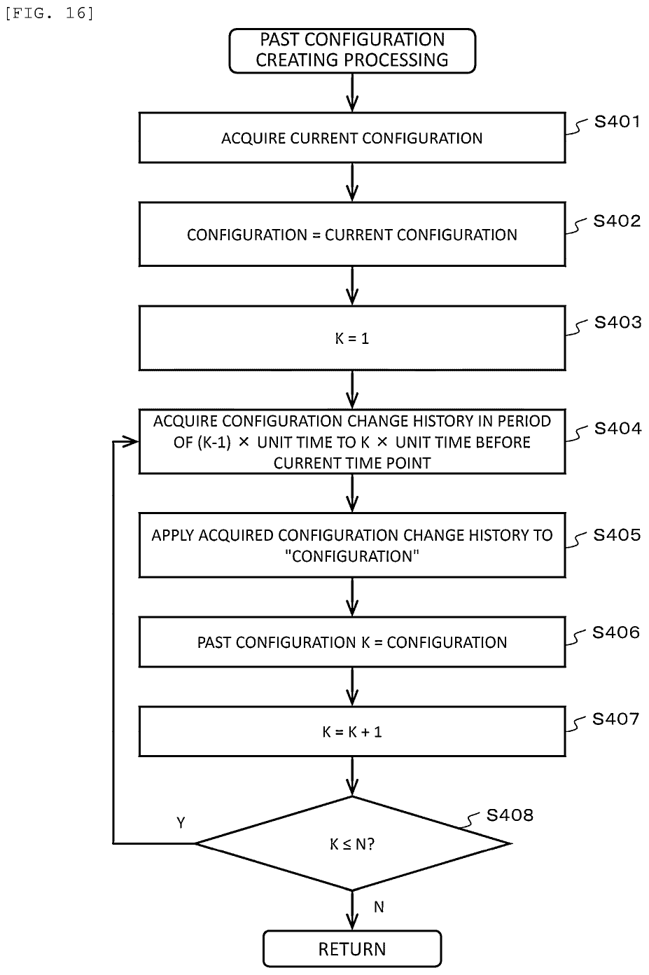

FIG. 13 is a flowchart of the plugin registering processing according to one embodiment.

The repository management program 121 of the repository computer 120 (technically, a processor which executes the repository management program 121) receives a new plugin, for example, via the network (S201). Note that the new plugin may be created by the management computer 100, or may be created by another device.

Then, the repository management program 121 registers the received plugin to the plugin repository 300 (S202).

By this plugin registering processing, a plugin which is newly required can be used by being registered to the plugin repository 300.

Next, processing operation by the management computer 100 is described.

FIG. 14 is a flowchart of the failure cause identification assisting processing according to one embodiment.

The failure cause identification assisting processing is executed when, for example, the management computer 100 detects occurrence of failure in the application, or occurrence of failure in the application is notified to the management computer 100.

The failure analysis program 200 of the management computer 100 (technically, the CPU 101 which executes the failure analysis program 200) receives an event set concerning the application where failure occurred (S100).

Then, the failure analysis program 200 estimates the configuration item (the suspected configuration item) which is suspected to be a cause of the failure based on the event set. Note that a known method can be utilized as a method of estimating the suspected configuration item.

Then, the failure analysis program 200 determines whether the past case DB includes an event pattern similar to an event pattern of the failure of this time (S102).

As a result of this, if it is determined that the past case DB includes the event pattern similar to the event pattern of the failure of this time (S102: Y), the failure analysis program 200 proposes, for example, through the input-and-output device 105, a handling measure of the past case in the past case DB (S103), and ends the processing. Here, as the processing at Steps S102 and S103, the technology disclosed in PTL 1 may be utilized. As described above, when included in the past case DB, by the handling measure being proposed, an appropriate handling measure can be proposed promptly.

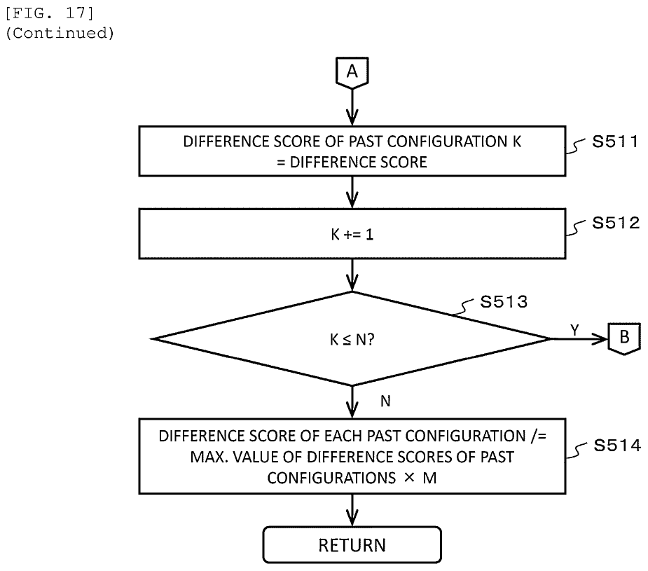

On the other hand, it is determined that the past case DB does not include the event pattern similar to the event pattern of the failure of this time (S102: N), the past case DB cannot be utilized, and thus, the failure analysis program 200 executes a difference score calculating processing (see FIG. 15) to the suspected configuration item (S104). In the difference score calculating processing, the difference score between the current configuration and the past configuration is calculated.

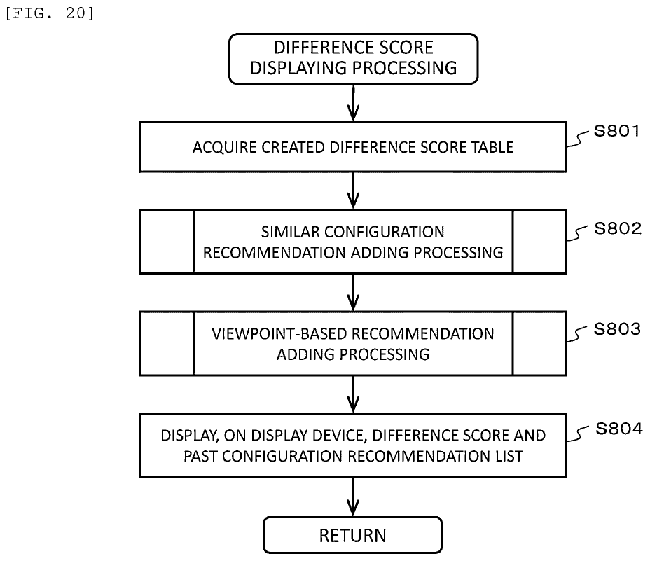

Then, the failure analysis program 200 executes a difference score displaying processing to display the difference score regarding the suspected configuration item (see FIG. 20), and ends the failure cause identification assisting processing.

Next, the difference score calculating processing at Step S104 is described.

FIG. 15 is a flowchart of the difference score calculating processing according to one embodiment.

The failure analysis program 200 acquires, from the storage device 103, the configuration information on the IT system (the application, the software, the storage, etc.) including the suspected configuration item (S301). Then, the failure analysis program 200 acquires, from the storage device 103, the configuration change history of the IT system (S302). Here, when N past configurations are acquired, an acquisition period of the configuration change history may be a period of time at or after a time point a unit time×N before the current time point.

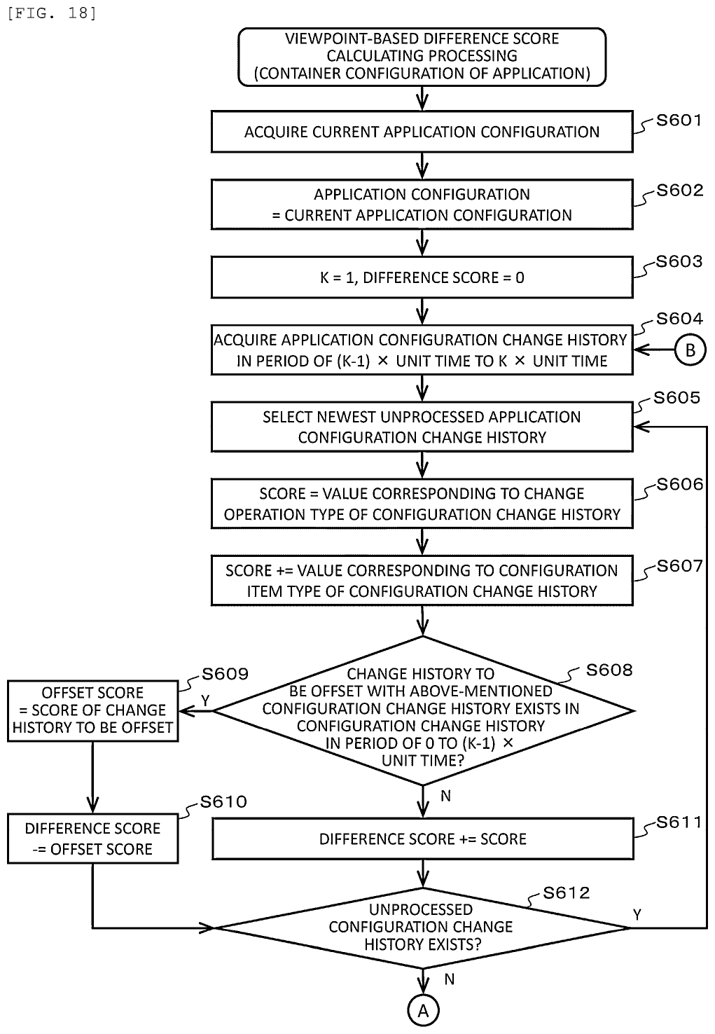

Then, the failure analysis program 200 executes a past configuration creating processing (see FIG. 16) to create a given number of (in this example, N) past configurations (S303).

Then, the failure analysis program 200 acquires, from the plugin repository 300 in the repository computer 120, the plugin 301 corresponding to the configuration item type of the suspected configuration item (S304).

Then, the failure analysis program 200 acquires, from the plugin 301, the viewpoint-based functions 303 regarding all the viewpoints and the measurement value difference calculation function 308 (S305).

Then, the failure analysis program 200 selects one unprocessed difference score calculation function in the measurement value difference calculation function 308 (S306), applies to each created past configuration the selected difference score calculation function to calculate the measurement value difference score (S307), and stores the calculated measurement value difference score in the corresponding field of the difference score table 1000 (S308).

Then, the failure analysis program 200 determines whether the processing is performed using all of the difference score calculation functions in the measurement value difference calculation function 308 (S309). If the processing is not performed using all of the difference score calculation functions (S309: N), the processing is proceeded to Step S306, and processing using the unprocessed difference score calculation function is performed.

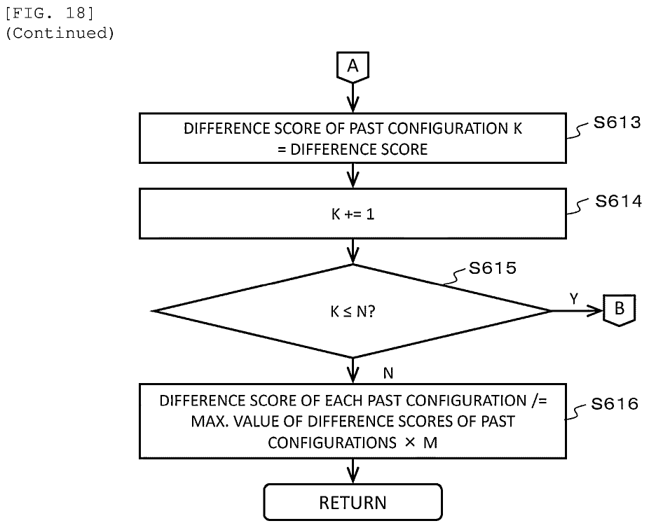

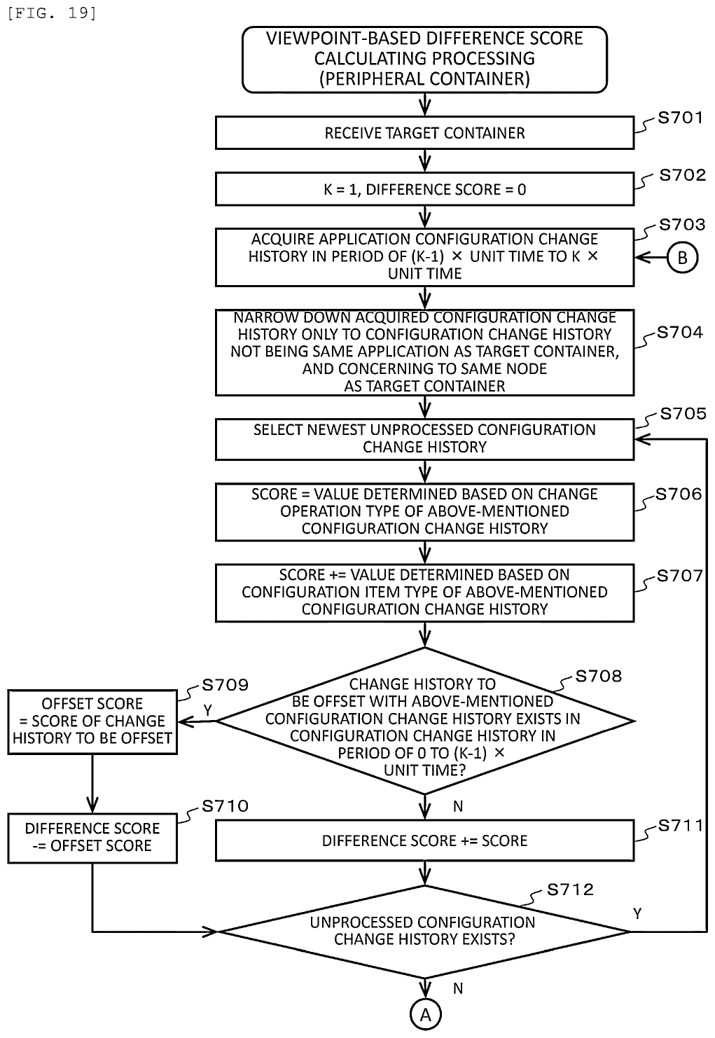

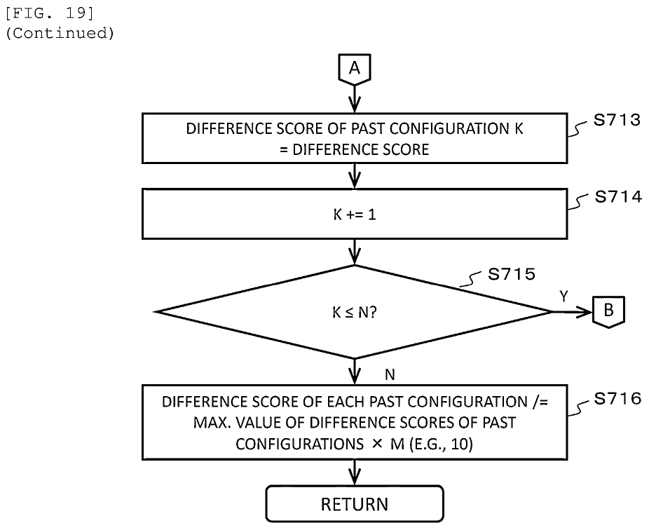

On the other hand, if the processing is performed using all of the difference score calculation functions (S309: Y), the failure analysis program 200 selects the viewpoint-based difference score calculation function 306 in an unprocessed viewpoint-based function 303 (S310), and executes the viewpoint-based difference score calculating processing to calculate the viewpoint-based difference scores of the respective past configurations by applying the selected viewpoint-based difference score calculation function to the N past configurations (S311). Here, as the viewpoint-based difference score calculating processing, for example, a viewpoint-based difference score calculating processing in the viewpoint of the software version of the application is a processing illustrated in FIG. 17, a viewpoint-based difference score calculating processing in the viewpoint of the container configuration of the application is a processing illustrated in FIG. 18, and a viewpoint-based difference score calculating processing in the viewpoint of the peripheral container is a processing illustrated in FIG. 19.

Then, the failure analysis program 200 stores, in the corresponding field of the difference score table 1000, the viewpoint-based difference scores acquired through the viewpoint-based difference score calculating processing (S312).

Then, the failure analysis program 200 determines whether the processing is performed for all the viewpoints (S313). As a result of this, if the processing is not performed for all the viewpoints (S313: N), the failure analysis program 200 proceeds the processing to Step S310, and if the processing is performed for all the viewpoints (S313: Y), the failure analysis program 200 ends the difference score calculating processing, and returns to the failure cause identification assisting processing.

Next, the past configuration creating processing at Step S303 is described.

FIG. 16 is a flowchart of the past configuration creating processing according to one embodiment.

The failure analysis program 200 acquires the current configuration from the configuration information (S401), sets the current configuration as a variable “configuration” (S402), and sets 1 as a variable K (S403).

Then, the failure analysis program 200 acquires the configuration change history in a period from (K−1)×a unit time to K×the unit time before a reference time point (in this example, the current time point) (S404).

Then, the failure analysis program 200 applies the acquired configuration change history to the “configuration”, and creates the past configuration of K×the unit time before (S405). In detail, the failure analysis program 200 creates the past condition by applying the change reverse of the acquired configuration change history.

Then, the failure analysis program 200 sets the past configuration K as the “configuration” (S406), and adds 1 to K (S407).

Then, the failure analysis program 200 determines whether K is at or smaller than N (S408). As a result of this, if K is at or smaller than N (S408: Y), this means that N past configurations are not yet generated, and thus, the failure analysis program 200 proceeds the processing to Step S404. On the other hand, if K is not at or smaller than N (S408: N), this means that N past configurations are generated, and thus, the failure analysis program 200 ends the past configuration creating processing, and returns to the failure cause identification assisting processing.

Next, the viewpoint-based difference score calculating processing at Step S311 is described.

FIG. 17 is a flowchart of the viewpoint-based difference score calculating processing (the version of software of the application) according to one embodiment.

The failure analysis program 200 acquires the current software configuration (S501), and sets the current software configuration as a variable “software configuration” (S502), and sets 1 as a variable K (S503).

Then, the failure analysis program 200 acquires a software configuration change history concerning the target application in a period from (K−1)×a unit time to K×the unit time before a reference time point (in this example, the current time point) (S504).

Then, the failure analysis program 200 sets 0 as the difference score (S505), and applies the acquired software configuration change history to the “software configuration” to create the software configuration of the past configuration of K×the unit time before (a past configuration K) (S506).

Then, the failure analysis program 200 selects one container from the current software configuration (S507), and determines whether the software configuration of the past configuration K includes the selected container (S508). As a result of this, if the software configuration of the past configuration K does not include the selected container (S508: N), the failure analysis program 200 proceeds the processing to Step S510.

On the other hand, if the software configuration of the past configuration K includes the selected container (S508: Y), the failure analysis program 200 adds to the difference score a score based on the difference in the version number of the container (S509), and proceeds the processing to Step S510. Here, as the score based on the difference in the version number, for example, in a case where the version number includes a major number, a minor number, and a patch number, the score may be 5 when the major number is different, the score may be 1 when the minor number is different, and the score may be 0.5 when the patch number is different.

At Step S510, the failure analysis program 200 determines whether an unprocessed container exists in the container of the current software configuration. If the unprocessed container exists (S510: Y), the failure analysis program 200 proceeds the processing to Step S507.

On the other hand, if the unprocessed container does not exist (S510: N), the failure analysis program 200 sets the value of the “difference score” as the difference score of the past configuration K (S511), adds 1 to K (S512), and determines whether K is at or smaller than N (S513).

As a result of this, if K is at or smaller than N (S513: Y), this means that the difference scores are not yet calculated for N past configurations, and thus, the failure analysis program 200 proceeds the processing to Step S504. On the other hand, if K is not at or smaller than N (S513: N), this means that the difference scores are created for N past configurations, and thus, the failure analysis program 200 sets the difference score of each past configuration to a value obtained by dividing the difference score of each past configuration by the maximum value of the difference scores of the past configurations×M (for example, 10) (S514), ends the viewpoint-based difference score calculating processing, and returns to the failure cause identification assisting processing. Here, the processing at Step S514 is a normalizing processing to manage the difference score calculated through this viewpoint-based difference score calculating processing not to become a large value with respect to the difference score calculated through the difference score calculating processing in the other viewpoints.

FIG. 18 is a flowchart of the viewpoint-based difference score calculating processing (the container configuration of the application) according to one embodiment.

The failure analysis program 200 acquires the current application configuration (S601), sets the current application configuration as a variable “application configuration” (S602), and sets 1 as a variable K and sets 0 as the difference score (S603).

Then, the failure analysis program 200 acquires an application configuration change history in a period from (K−1)×a unit time to K×the unit time before a reference time point (in this example, the current time point) (S604).

Then, the failure analysis program 200 selects the newest unprocessed application configuration change history (referred to as a “target application configuration change history” in the description of this processing) in the acquired application configuration change history (S605), and sets, as a variable “score”, a value corresponding to the type of the change operation of the target application configuration change history (S606). Here, as the value corresponding to the type of the change operation, for example, the value may be 2 in the case of deleting, and the value may be 1 in the case of adding.

Then, the failure analysis program 200 adds to the “score” a value corresponding to the configuration item type of the target application configuration change history (S607). Here, as the value corresponding to the configuration item type, for example, the value may be 1 in the case of the container, and the value may be 2 in the case of the pod.

Then, the failure analysis program 200 determines whether an application configuration change history in a period from 0 to (K−1)×the unit time before the reference time point (in this example, the current time point) includes a change history to be offset with the target application configuration change history (S608). Here, the change history to be offset with the target application configuration change history is a change history of applying a reverse change operation to the same configuration item (for example, deletion of a container with respect to addition of the same container). In this embodiment, in order to prevent increase in the difference score regardless of the change to restore to the original state, an offset processing (S609 and S610) to adjust the score in such a case is executed (described later).

As a result of this, if it is determined that the change history to be offset exists (S608: Y), the failure analysis program 200 sets, as a offset score, a score regarding the change history to be offset (S609), subtracts the offset score from the difference score (S610), and proceeds the processing to Step S612. On the other hand, if it is determined that the change history to be offset does not exist (S608: N), the failure analysis program 200 adds the value of the score to the difference score (S611), and proceeds the processing to Step S612.

At Step S612, the failure analysis program 200 determines whether an unprocessed application configuration change history exists in the acquired application configuration change history. If the unprocessed application configuration change history exists (S612: Y), the failure analysis program 200 proceeds the processing to Step S604.

On the other hand, if the unprocessed application configuration change history does not exist (S612: N), the failure analysis program 200 sets the value of the “difference score” as the difference score of the past configuration K (S613), adds 1 to K (S614), and determines whether K is at or smaller than N (S615).

As a result of this, if K is at or smaller than N (S615: Y), this means that the difference scores are not yet calculated for N past configurations, and thus, the failure analysis program 200 proceeds the processing to Step S604. On the other hand, if K is not at or smaller than N (S615: N), this means that the difference scores are created for N past configurations, and thus, the failure analysis program 200 sets the difference score of each past configuration to a value obtained by dividing the difference score of each past configuration by the maximum value of the difference scores of the past configurations×M (for example, 10) (S616), ends the viewpoint-based difference score calculating processing, and returns to the failure cause identification assisting processing. Here, the processing at Step S616 has an effect similar to Step S514.

FIG. 19 is a flowchart of the viewpoint-based difference score calculating processing (the peripheral container) according to one embodiment. Here, behavior of a peripheral container of one container may affect operation of the one container. For example, when the peripheral container consumes a large amount of CPU and I/O, or consumes a large amount of OS resources such as a page cache, decrease in performance is caused to the target container. In this respect, in the viewpoint-based difference score calculating processing (the peripheral container), difference in influence of the peripheral container between the current configuration and the past configuration is calculated as the difference score.

The failure analysis program 200 receives the name of the container which is a calculation target (a target container) (S701), sets 1 as a variable K, and sets 0 as the difference score (S702).

Then, the failure analysis program 200 acquires an application configuration change history in a period from (K−1)×a unit time to K×the unit time before a reference time point (in this example, the current time point) (S703).

Then, the failure analysis program 200 narrows down the acquired application configuration change history only to an application configuration change history concerning a container (the peripheral container) which does not execute the application same as the target container, and exists in the node same as the target container (S704).

Then, the failure analysis program 200 selects the newest unprocessed application configuration change history (referred to as the “target application configuration change history” in the description of this processing) in the narrowed-down application configuration change history (S705), and sets, as a variable “score”, the value corresponding to the type of the change operation of the target application configuration change history (S706). Here, as the value corresponding to the type of the change operation, for example, the value may be 2 in the case of deleting, and the value may be 1 in the case of adding.

Then, the failure analysis program 200 adds to the “score” the value corresponding to the configuration item type of the target application configuration change history (S707). Here, as the value corresponding to the configuration item type, for example, the value may be 1 in the case of the container, and the value may be 2 in the case of the pod.

Then, the failure analysis program 200 determines whether an application configuration change history in a period from 0 to (K−1)×the unit time before the reference time point (in this example, the current time point) includes a change history to be offset with the target application configuration change history (S708). Here, the change history to be offset with the target application configuration change history is a change history of applying a reverse change operation to the same configuration item (for example, deletion of a container with respect to addition of the same container). In this embodiment, in order to prevent increase in the difference score regardless of the change to restore to the original state, an offset processing (S709 and S710) to adjust the score in such a case is executed (described later).

As a result of this, if it is determined that the change history to be offset exists (S708: Y), the failure analysis program 200 sets, as the offset score, a score regarding the change history to be offset (S709), subtracts the offset score from the difference score (S710), and proceeds the processing to Step S712. On the other hand, if the failure analysis program 200 determines that the change history to be offset does not exist (S708: N), the failure analysis program 200 adds the value of the score to the difference score (S711), and proceeds the processing to Step S712.

At Step S712, the failure analysis program 200 determines whether an unprocessed application configuration change history exists in the narrowed-down application configuration change history. If the unprocessed application configuration change history exists (S712: Y), the failure analysis program 200 proceeds the processing to Step S705.

On the other hand, if the unprocessed application configuration change history does not exist (S712: N), the failure analysis program 200 sets s the value of the “difference score” as the difference score of the past configuration K (S713), adds 1 to K (S714), and determines whether K is at or smaller than N (S715).

As a result of this, if K is at or smaller than N (S715: Y), this means that the difference scores are not yet calculated for N past configurations, and thus, the failure analysis program 200 proceeds the processing to Step S703. On the other hand, if K is not at or smaller than N (S715: N), this means that the difference scores are created for N past configurations, and thus, the failure analysis program sets the difference score of each past configuration to a value obtained by dividing the difference score of each past configuration by the maximum value of the difference scores of the past configurations×M (for example, 10) (S716), ends the viewpoint-based difference score calculating processing, and returns to the failure cause identification assisting processing. Here, the processing at Step S716 has an effect similar to Step S514.

Next, the difference score displaying processing at Step S105 is described.

FIG. 20 is a flowchart of the difference score displaying processing according to one embodiment.

The failure analysis program 200 acquires the difference score table 1000 (S801) which is created through the difference score calculating processing (S104), and executes the similar configuration recommendation adding processing (see FIG. 21) (S802). In the similar configuration recommendation adding processing, a similar configuration whose configuration is the most similar to the current configuration among the plurality of past configurations, is added to the past configuration recommendation list.

Then, the failure analysis program 200 executes a viewpoint-based recommendation list adding processing (see FIG. 22) in which the past configuration to be referred is identified and added to the past configuration recommendation list for each viewpoint.

Then, the failure analysis program 200 displays the screen (the difference score calculation result screen 1100) including the difference score and the past configuration recommendation list, ends the difference score displaying processing, and returns to the failure cause identification assisting processing.

Next, the similar configuration recommendation adding processing difference score displaying processing at Step S802 is described.

FIG. 21 is a flowchart of the similar configuration recommendation adding processing according to one embodiment.

The failure analysis program 200 calculates, regarding each past configuration, an average difference score A which is an average value of the difference scores in terms of the measurement values (S901).

Then, the failure analysis program 200 sets the average difference score A of the measurement values to a value obtained by dividing the average difference score A by the maximum value of the difference scores of the past configuration's measurement values×M (for example, 10) (S902). This processing has an effect similar to Step S514.

Then, the failure analysis program 200 calculates, regarding each past configuration, an average difference score B which is an average value of the viewpoint-based difference scores (S903).

Then, the failure analysis program 200 calculates “average difference score A-average difference score B” (S904), adds, to the past configuration recommendation list, a given number of past configurations in the order of having a larger value obtained by “A−B” (S905), ends the similar configuration recommendation adding processing, and returns to the difference score displaying processing. Here, the similar configuration recommendation adding processing is a processing to add, to the recommendation list, the past configuration which is similar to the current configuration (that is, the average value of the average difference scores B regarding the viewpoints is small), but which is largely different in the output of the performance value, the log, and the event (that is, the average difference score A of the measurement values is large). This processing is based on an idea that in a case where a configuration is similar but output of a log and an event is different, detailed examination of the log and event is highly likely to lead to finding a cause of failure.

Next, the viewpoint-based recommendation adding processing at Step S803 is described.

FIG. 22 is a flowchart of the viewpoint-based recommendation adding processing according to one embodiment.

The failure analysis program 200 calculates, regarding each past configuration, the average difference score A which is the average value of the difference scores in terms of the measurement values (S1001).

Then, the failure analysis program 200 sets the average difference score A of the measurement values to a value obtained by dividing the average difference score A by the maximum value of the difference scores of the past configuration's measurement values×M (for example, 10) (S1002). This processing has an effect similar to Step S514.

Then, the failure analysis program 200 selects one unprocessed viewpoint (S1003), and calculates, regarding each past configuration, the average difference score B which is the average value of the viewpoint-based difference scores excluding the selected viewpoint (S1004).

Then, the failure analysis program 200 acquires a difference score C of the selected viewpoint (S1005), and sets the difference score C to a value obtained by multiplying the difference score C by the beneficialness coefficient of the selected viewpoint (S1006).

Then, the failure analysis program 200 calculates “average difference score A+difference score C−average difference score B” (S1007), and adds a given number of (for example, N) past configurations to a past configuration recommendation candidate list in the order of having a larger value obtained by “A+C−B” (S1008).

Then, the failure analysis program 200 determines whether the processing is performed for all the viewpoints (S1009), and if the processing is not performed for all the viewpoints (S1009: N), the failure analysis program 200 proceeds the processing to Step S1003.

On the other hand, if the processing is performed for all the viewpoints (S1009: Y), the failure analysis program 200 adds, to the past configuration recommendation list, a given number of (for example, N) past configurations in the past configuration recommendation candidate list in the order of having a larger value obtained by “A+C−B” (S1010). Then, the failure analysis program 200 ends the viewpoint-based recommendation adding processing, and returns to the difference score displaying processing. Here, the viewpoint-based recommendation adding processing is a processing to add, to the recommendation list, a past configuration having a large difference (the difference score C) in a certain viewpoint (for example, the viewpoint of the peripheral container), having a small difference (the average difference score B) in the other viewpoints, and having a large difference (the average difference score A) in the output of the log and the event. This processing is based on an idea that detailed examination of a log and an event of such a past configuration is highly likely to lead to finding a cause of failure.

Next, the difference detail displaying processing will be described.

FIG. 23 is a flowchart of the difference detail displaying processing according to one embodiment. The difference detail displaying processing is, for example, a processing which is executed when the viewpoint-based difference score range of the past configuration in the difference score table displaying range 1102 in FIG. 11 is pressed.

The failure analysis program 200 receives information on a specified past configuration and a specified viewpoint of a specified target configuration item (the target configuration item) (S1101), and determines whether the specified past configuration is included in the past configuration recommendation list (S1102).

As a result of this, if the specified past configuration is included in the past configuration recommendation list (S1102: Y), the failure analysis program 200 displays the beneficialness button 1205 on the difference detail screen 1200 (S1103), and acquires, from the plugin repository 300, the plugin corresponding to the type of the target configuration item (S1104). On the other hand, if the specified past configuration is not included in the past configuration recommendation list (S1102: N), the failure analysis program 200 acquires, from the plugin repository 300, the plugin 301 corresponding to the type of the target configuration item (S1104).

Then, the failure analysis program 200 acquires, from the plugin 301, information on the specified viewpoint and the difference display function 307 corresponding to the specified viewpoint (S1105), and identifies a different point between the specified past configuration and the current configuration by using the difference display function 307 (S1106).

Then, the failure analysis program 200 displays on the difference detail screen 1200 a chart of the current configuration and the specified past configuration, displays the different point (for example, the added or deleted point) to be highlighted, displays the difference between the current and past configurations regarding the measurement value difference in the specified past configuration (S1107), and ends the difference detail displaying processing.

Next, the beneficialness coefficient updating processing is described.

FIG. 24 is a flowchart of the beneficialness coefficient updating processing according to one embodiment. The beneficialness coefficient updating processing is executed, for example, when the beneficialness button 1205 on the difference detail screen 1200 is pressed.

The failure analysis program 200 receives information (feedback information) that the beneficialness button 1205 is pressed, and acquires the viewpoint based on the target past configuration on the difference detail screen 1200 (S1201). Then, the failure analysis program 200 executes a processing to add the beneficialness coefficient of the acquired viewpoint, and reflect the beneficialness coefficient to the plugin repository 300 (S1202). For example, the failure analysis program 200 adds a given value (α) to a beneficial-time coefficient of the plugin repository 300, and ends the beneficialness coefficient updating processing.

Note that the invention is not limited to the embodiment described above, but may be embodied while suitably being modified without departing from the scope of the invention.

For example, in the embodiment described above, the difference scores are calculated regarding a plurality of past configurations. However, the invention is not limited to this configuration, but the difference scores may be calculated regarding a single past configuration.

Moreover, in the embodiment described above, the difference scores are displayed through execution of the difference score calculating processing and the difference score displaying processing, regarding the suspected configuration item in the case of occurrence of failure. However, the invention is not limited to this configuration, but, for example, the difference scores may be calculated and displayed through execution of the difference score calculating processing and the difference score displaying processing, regarding a configuration item which is specified by a user regardless of occurrence of failure.

Moreover, in the embodiment described above, the viewpoint-based difference scores and the measurement value difference scores are calculated regarding the past configurations. However, the invention is not limited to this configuration, but only the viewpoint-based difference scores may be calculated.

Moreover, a part of or the entire processing which is executed by the processor in the embodiment described above may be executed by a hardware circuit. Moreover, the program in the above embodiment may be installed from a program source. The program source may be a program distribution server or a recording medium (for example, a removable recording medium).

### REFERENCE SIGNS LIST

1: computer system
10: application
20: configuration information
30: configuration change history
100: management computer
101: CPU
102: memory
103: storage device
110: network
120: repository computer
130 (130A, 130B, etc.): cluster
131 (131A, 131B, etc.): node
140 (140A, 140B, etc.): storage

1. A failure cause identification assisting apparatus configured to assist in identifying a cause of failure concerning execution of an application, the failure cause identification assisting apparatus comprising:
a processor; and
a storage device, wherein
the storage device stores configuration information concerning configurations at a plurality of time points regarding a given target configuration object concerning execution of the application, and
the processor calculates a viewpoint-based difference score that is a difference score in each of a plurality of viewpoints between a current configuration and a past configuration regarding the given target configuration object concerning execution of the application.

2. The failure cause identification assisting apparatus according to claim 1, wherein the target configuration object is a container configured to execute the application, and
the plurality of viewpoints include any two or more of a viewpoint regarding software included in the application executed by the container, a viewpoint regarding a peripheral container that is a container existing at a periphery of the container, and a viewpoint regarding a time window during which the application is executed by the container.

3. The failure cause identification assisting apparatus according to claim 1, wherein the processor displays the calculated viewpoint-based difference score.

4. The failure cause identification assisting apparatus according to claim 1, wherein the processor calculates the viewpoint-based difference score between the current configuration and each of past configurations at a plurality of time points.

5. The failure cause identification assisting apparatus according to claim 4, wherein the processor determines a recommended past configuration and a recommended viewpoint based on the plurality of viewpoint-based difference scores, the recommended past configuration being a past configuration suitable for identifying a cause of failure of the target configuration object, and the recommended viewpoint being a viewpoint to be focused on.

6. The failure cause identification assisting apparatus according to claim 4, wherein the processor calculates the viewpoint-based difference scores of the past configurations at the plurality of time points by accumulating, in an order from the past configuration at a time point closer to a current time point, the difference score with respect to the configuration at the time point immediately prior, and
when the configuration at one time point includes a part that is the same as a part in the configuration at any time point closer than the one time point to the current time point, the difference score is assumed not to exist in the part.

7. The failure cause identification assisting apparatus according to claim 5, wherein the processor displays the recommended past configuration and the recommended viewpoint.

8. The failure cause identification assisting apparatus according to claim 7, wherein the processor receives, from a user, feedback information indicating that the recommended past configuration and the recommended viewpoint are appropriate, and
the processor determines, in accordance with the feedback information, a coefficient used to adjust the viewpoint-based difference score regarding the viewpoint corresponding to the recommended viewpoint in terms of the target configuration object.

9. The failure cause identification assisting apparatus according to claim 3, wherein when the calculated viewpoint-based difference score is larger than a given value, the processor displays the viewpoint-based difference score to be highlighted.

10. The failure cause identification assisting apparatus according to claim 1, wherein the storage device stores measurement value information concerning a given measurement value at the plurality of time points, the given measurement value being measured in execution of the application, and
the processor calculates, based on the measurement value information, a measurement value difference score that is a difference score between the current configuration and the past configuration regarding the measurement value in execution of the application.

11. The failure cause identification assisting apparatus according to claim 1, wherein the processor detects occurrence of failure during execution of the application, and identifies a suspected configuration object that is a configuration object suspected to be a cause of the failure, and
the suspected configuration object is the target configuration object.

12. The failure cause identification assisting apparatus according to claim 1, wherein the storage device stores past case information that is information concerning a past case occurred during execution of the application, and
the processor is adapted to:
detect occurrence of failure during execution of the application;
display the past case information when the past case information includes a case similar to the detected failure; and
calculate the viewpoint-based difference score by setting a suspected configuration object as the target configuration object when the past case information does not include the case similar to the detected failure, the suspected configuration object being a configuration object suspected to be a cause of the failure.

13. A method of assisting failure cause identification by a failure cause identification assisting apparatus configured to assist in identifying a cause of failure concerning execution of an application, comprising the steps of:
storing configuration information concerning configurations at a plurality of time points regarding a given target configuration object concerning execution of the application; and
calculating a viewpoint-based difference score that is a difference score in each of a plurality of viewpoints between a current configuration and a past configuration regarding the given target configuration object concerning execution of the application.

14. A failure cause identification assisting program configured to cause a computer to execute processing to assist in identifying a cause of failure concerning execution of an application, wherein
the computer stores configuration information concerning configurations at a plurality of time points regarding a given target configuration object concerning execution of the application, and
the failure cause identification assisting program causes the computer to calculate a viewpoint-based difference score that is a difference score in each of a plurality of viewpoints between a current configuration and a past configuration regarding the given target configuration object concerning execution of the application.
